(19) United States
(12) Patent Application Publication
(10) Pub. No.: US 2020/0340543 A1
(43) Pub. Date: Oct. 29, 2020

(54) ARTICLE, IN PARTICULAR AIR SPRING BELLOWS, A METAL-RUBBER ELEMENT, OR A VIBRATION DAMPER

(71) Applicant: ContiTech Luftfedersysteme GmbH, Hannover (DE)

(72) Inventors: Thorsten Leethaus, Eschershausen (DE); Dieter Borvitz, Hannover (DE); Klaus Schobert, Nienburg (DE); Barbara Passon-Wesseloh, Goettingen (DE); Jens Storre, Noerten-Hardenberg (DE)

(73) Assignee: ContiTech Luftfedersysteme GmbH, Hannover (DE)

(21) Appl. No.: 16/956,361

(22) PCT Filed: Dec. 17, 2018
(86) PCT No.: PCT/EP2018/085131

§ 371 Date: Jun. 19, 2020

(30) Foreign Application Priority Data
Dec. 21, 2017 (DE) 10 2017 223 538.1

(51) Int. Cl. F16F 1/36; C08L 11/00; C08L 21/00; C08L 7/00

(52) U.S. Cl. CPC F16F 1/3605; C08L 11/00; C08K 2003/2224; C08L 7/00; C08L 21/00

(57) ABSTRACT

The invention relates to an article having a single-layered or multilayered main body having elastic properties, in particular an air spring bellows, a metal-rubber element or a vibration damper.

To improve the flame-retardant properties the main body of the article consists of or contains at least one layer D which is constructed from a rubber mixture which is free from halogen-containing flame retardants and contains at least one carbon black having a BET surface area according to DIN-ISO 9277 between 35 and 140 m²/g and an oil absorption number (OAN) according to ISO 4656 between 70 and 140 ml/100 g.

The invention relates to an article having a single- or multilayered main body having elastic properties, in particular an air spring bellows, a metal-rubber element or a vibration damper.

Articles having elastic properties that are used for the suspension of, for example, motor vehicles or rail vehicles and/or vibration damping are made using elastomeric mixtures, also known as rubber mixtures. These elastomeric mixtures typically used for the fundamental properties of such articles are well known. Articles having outstanding elastic properties, for example metal-rubber elements or vibration dampers, preferentially contain vulcanized mixtures of rubber which are predominantly based on natural rubber (NR) and/or polyisoprene rubber (IR). Articles having very good resistance to weathering, mineral oil and heat, examples being air spring bellows, preferentially contain vulcanized mixtures of rubber which are predominantly based on chloroprene rubber (CR).

However, articles comprising these elastomeric mixtures display distinct disadvantages in fire behavior. The evolution of thick smoke is one of the consequences of a fire. The heat release rate is particularly high in the combustion process of the aforementioned elastomeric mixtures which are predominantly based on NR and/or IR. The evolving smoke from the combustion process of the elastomeric mixtures based predominantly on CR is toxic to humans and animals.

The recent increase in fire safety requirements as reflected above all in the tightened fire safety standard EN45545 is driving an increased need for polymer articles optimized for fire safety. These fire safety requirements are no longer met either by the aforementioned elastomeric mixtures that are predominantly based on NR and/or IR, above all because of the required maximum heat release rate, but also the flame-resistant elastomeric mixtures that are predominantly based on CR, particularly because of the required smoke toxicity. Articles containing these elastomeric mixtures thus usually no longer meet the tightened requirements.

A customary method of improving fire behavior of rubber mixtures is direct incorporation of sometimes comparatively large amounts of flame-retardant substances. However in the mixtures concerned this measure generally results in impairment of physical properties, especially hardness for example, which is relevant for use in dynamic applications. This is reflected in the articles concerned especially in significantly impaired cushioning, settling or vibration properties.

The present invention accordingly has for its object to provide an article having optimized fire safety behavior in order to meet stricter requirements, especially those described in EN-45545. In particular, at least Hazard Level 2, as described in the standard, shall be achieved. At the same time, the necessary physical properties of the article, especially hardness for example, shall remain at a comparable level.

This object is achieved by the article having a single- or multilayered main body having elastic properties, wherein at least one layer D of the main body is constructed from a rubber mixture which is free from halogen-containing flame retardants and contains at least one carbon black having a BET surface area according to DIN-ISO 9277 between 35 and 140 m²/g and an oil absorption number (OAN) according to ISO 4656 between 70 and 140 ml/100 g.

It has now been found that, surprisingly, the use of such finely divided carbon blacks has a positive effect on fire behavior. This makes it possible to significantly reduce the amount of further additional flame retardants. The lower required amount of additional flame retardants improves the dynamic suitability of the rubber mixture, thus resulting in an extended lifespan of the article. Especially when using a blend of chloroprene rubber and natural rubber, the amount of additional flame retardants can be reduced without sacrificing the dynamic properties of the rubber mixture.

According to the invention at least one carbon black having a BET surface area according to DIN-ISO 9277 between 35 and 140 m²/g and an oil absorption number (OAN) according to ISO 4656 between 70 and 140 ml/100 g is employed. This means it is preferable to employ carbon blacks designated N-1xy, N-2xy, N-3xy, N-4xy or N-5xy, wherein x and y may each independently of one another be an integer between 0 and 9. The carbon blacks are designated according to the classification table of ASTM D 1765-06.

Particularly good properties are achieved by N550 and N339 carbon blacks.

The recited carbon blacks having the designations N-1xy, N-2xy, N-3xy, N-4xy or N-5xy may be employed alone or in combination.

In a particularly preferred embodiment N339 and N550 carbon blacks are each employed alone or in combination. These two types are particularly suitable in terms of fire safety behavior, especially N339 in this case, abrasion resistance, especially N550 in this case, and dynamic properties.

The total amount of the employed carbon black is preferably 5 to 30 phr. If more than one carbon black having the properties according to claim 1 is employed then the amount of 5 to 30 phr relates to the total amount of carbon blacks having the properties according to claim 1.

In a preferred embodiment the rubber mixture of the layer D also contains at least one further flame retardant.

Contemplated here are in particular stannates, such as zinc stannate or zinc hydroxystannate, further hydroxides, such as magnesium hydroxide or calcium hydroxide, cyanurates, such as melamine cyanurate, borates, such as zinc borate or calcium borate, phosphorus-containing components, such as resorcinol diphosphate, melamine phosphate or aromatic polyphosphates, nitrogen-containing components, such as ammonium phosphate, intumescent mixtures, carbonates, such as calcium carbonate or magnesium carbonate, or expandable graphite.

Intumescent mixtures expand to afford foams. They are used to provide protection from the effects of heat and fire to combustible materials such as plastics or wood, and also steel, which suffers a loss of strength at elevated temperature.

It is optionally also possible to employ small amounts of antimony trioxide in combination with at least one of the recited flame retardants despite its health-hazardous properties. However, it has proven particularly advantageous when the rubber mixture of the layer D still contains at least zinc hydroxystannate or zinc stannate, alone or in combination. Zinc hydroxystannate or zinc stannate are preferably used in a total amount of 0.5 to 5 phr and exhibit particularly good advantages in terms of smoke gas density.

In an advantageous embodiment the rubber mixture of the layer D also contains at least one acid scavenger which further reduces the toxicity of the resulting smoke gas. The acid scavenger is preferably at least one oxide, wherein calcium oxide and magnesium oxide are particularly suitable alone or in combination.

The rubber mixture of the layer D contains at least one rubber component, which is preferably selected from the group consisting of ethylene-propylene copolymer (EPM) and/or ethylene-propylene-diene copolymer (EPDM) and/or nitrile rubber (NBR) and/or carboxylated nitrile rubber (XNBR) and/or (partially) hydrogenated nitrile rubber (HNBR) and/or fluorine rubber (FKM) and/or chloroprene rubber (CR) and/or natural rubber (NR) and/or epoxidized natural rubber (ENR) and/or isoprene rubber (IR) and/or styrene-butadiene rubber (SBR) and/or carboxylated styrene-butadiene rubber (XSBR) and/or butyl rubber (IIR) and/or bromobutyl rubber (BIIR) and/or chlorobutyl rubber (CIIR) and/or butadiene rubber (BR) and/or chlorinated polyethylene (CM) and/or chlorosulfonated polyethylene (CSM) and/or alkylated chlorosulfonated polyethylene (ACSM) and/or polyepichlorohydrin rubbers (CO; ECO; ETER) and/or ethylene-vinyl acetate rubber (EVA) and/or acrylate rubber (ACM) and/or ethylene-acrylate rubber (AEM) and/or silicone rubber (MQ, VMQ, PVMQ, FVMQ) and/or fluorinated methylsilicone rubber (MFQ) and/or perfluorinated propylene rubber (FFPM) and/or perfluorocarbon rubber (FFKM) and/or polyurethane (PU).

The recited rubbers may be employed alone or in a blend.

The rubber component of the rubber mixture of the layer D preferably consists of a rubber or of a rubber blend of at least two rubbers which each provide the mixture with a primarily low flammability and/or have good physical properties for use in dynamically highly stressed articles. These include in particular NR, ENR, IR, CR, CM, CSM, ACSM, BR, NBR, XNBR, HNBR. In a particularly preferred embodiment the rubber component of the rubber mixture of the layer D consists of 100 phr of CR or of a rubber blend of CR and NR.

The main body may either be constructed only of the layer D or else may contain at least one further layer.

If further layers are present then the layer D is preferably the outermost outward-facing layer of the article.

However, it is also possible for the layer D to be embedded between further layers.

If the layer D is the outermost layer or if the layer D is embedded between further layers, it may be the case in a preferred embodiment that the layer D does not completely envelop the main body but rather is merely partially present, especially in places particularly exposed to fire risk.

Thus for example a further layer A which forms the so-called “inner cap” and which is constructed from an elastomer mixture and has particularly good elastic properties may be present. The elastomer mixture is a vulcanizable, preferably thermoplastic-free, rubber mixture containing at least one rubber component and further mixing ingredients. Contemplated rubber components especially include: ethylene-propylene rubber (EPM), ethylene-propylene-diene rubber (EPDM), nitrile rubber (NBR), carboxylated nitrile rubber (XNBR), (partially) hydrogenated nitrile rubber (HNBR), fluoro rubber (FKM), chloroprene rubber (CR), natural rubber (NR), epoxidized natural rubber (ENR), isoprene rubber (IR), styrene-butadiene rubber (SBR), carboxylated styrene-butadiene rubber (XSBR), butyl rubber (IIR), bromobutyl rubber (BIIR), chlorobutyl rubber (CIIR), brominated copolymer of isobutylene and para-methylstyrene (BIMS), butadiene rubber (BR), chlorinated polyethylene (CM), chlorosulfonated polyethylene (CSM), alkylated chlorosulfonated polyethylene (ACSM), polyepichlorohydrin rubbers (CO; ECO; ETER), ethylene-vinyl acetate rubber (EVA), acrylate rubber (ACM), ethylene-acrylate rubber (AEM), silicone rubber (MQ, VMQ, PVMQ, FVMQ), fluorinated methylsilicone rubber (MFQ), perfluorinated propylene rubber (FFPM), perfluorocarbon rubber (FFKM), polyurethane (PU).

The abovementioned rubber types may be unblended. The use of a blend is also possible. The rubber type preferred depends on the article type and the demands on the individual article. The usual mixture ingredients comprise at least one crosslinker or one crosslinker system (crosslinking agent and accelerator). Additional mixture ingredients are usually at least one filler and/or at least one processing aid and/or at least one plasticizer, for example phosphate ester plasticizers, and/or at least one aging stabilizer and optionally further additives, for example color pigments, reinforcing fibers, etc.

Reference is made in this connection to the general art of rubber mixing technology. The composition of the rubber mixture of the layer A may be qualitatively and/or quantitatively identical or different to the rubber mixture of the layer D.

If the rubber mixture of the layer A is qualitatively and quantitatively identical to the rubber mixture of the layer D, i.e. similarly fire-retarded, the fire-promoting gases and substances formed in case of fire can pass through to the outside only with a delay, if at all, and can thus amplify an article fire only to a reduced extent, if at all. In addition, any strength member layers present which may be fast-melting, see layer B, are thus better protected or do not pass through to the outside.

At least one layer B which is formed from at least one strength member may also be present in a particular embodiment. This is preferably a cord fabric composed of one or more plies, preferably of two plies, having good adhesion to the layer A. In a very particularly preferred embodiment this is a BiStretch fabric as described for example in WO 2016045813 A1.

Materials used for the layer B may be any known synthetic and natural materials alone or in combination, i.e. in the form of a hybrid fabric.

Contemplated synthetic materials especially include synthetic polymers, for example acrylonitrile, polyacrylonitrile, polypropylene, polyester, polyamide, polyurethane, polyphenylene sulfide, polyoxadiazole, aramids, such as p-aramid, m-aramid or copoly-para-aramid, polyimide, polyetherimide, polyetheretherketone, polyethylene 2,6-naphthalate, polyphenylene, polyphenylene oxide, polyphenylene sulfide, polyphenylene ether, polybenzoxazoles, polyvinyl alcohol.

The natural materials may be rockwool or asbestos, cotton, flax or hemp, or wool or silk. Inorganic materials such as glass, ceramic, carbon, metal, for example steel, or stone, for example basalt, are likewise conceivable.

Preference is given to polyamide, especially PA 6,6, or polyester, alone or in combination. In order to achieve sufficient processing stickiness during the production process for the article the cord fabric may be rubberized or frictionized on one or both sides. Rubberization may preferably be accomplished either using a composition which is quantitatively and/or qualitatively identical to the composition for the layer C or is quantitatively and/or qualitatively identical to the composition for the layer A. This simplifies the production process for the article and contributes to a dynamically suitable adhesive bond.

In a further preferred embodiment the article may further contain at least one additional layer C.

The layer C then forms the so-called “outer cap” of the article. The layer C may be a one-ply or two-ply layer. The elastomer mixture of the layer C is a vulcanizable, preferably thermoplastic-free, rubber mixture containing at least one rubber component and further mixture ingredients. Contemplated rubber components especially include: ethylene-propylene rubber (EPM), ethylene-propylene-diene rubber (EPDM), nitrile rubber (NBR), carboxylated nitrile rubber (XNBR), (partially) hydrogenated nitrile rubber (HNBR), fluoro rubber (FKM), chloroprene rubber (CR), natural rubber (NR), epoxidized natural rubber (ENR), isoprene rubber (IR), styrene-butadiene rubber (SBR), carboxylated styrene-butadiene rubber (XSBR), butyl rubber (IIR), bromobutyl rubber (BIIR), chlorobutyl rubber (CIIR), brominated copolymer of isobutylene and para-methylstyrene (BIMS), butadiene rubber (BR), chlorinated polyethylene (CM), chlorosulfonated polyethylene (CSM), alkylated chlorosulfonated polyethylene (ACSM), polyepichlorohydrin rubbers (CO; ECO; ETER), ethylene-vinyl acetate rubber (EVA), acrylate rubber (ACM), ethylene-acrylate rubber (AEM), silicone rubber (MQ, VMQ, PVMQ, FVMQ), fluorinated methylsilicone rubber (MFQ), perfluorinated propylene rubber (FFPM), perfluorocarbon rubber (FFKM), polyurethane (PU).

The abovementioned rubber types may be unblended. The use of a blend is also possible. The type of rubber preferred depends on the nature of the article. The usual mixture ingredients comprise at least one crosslinker or one crosslinker system (crosslinking agent and accelerator). Additional mixture ingredients usually further include a filler and/or a processing aid and/or a plasticizer and/or an aging stabilizer and also optionally further additives (for example color pigments, adhesion promoters, flame retardants, reinforcing fibers).

Reference is made in this connection to the general art of rubber mixing technology.

The article may also contain at least one further layer E based on at least one thermoplastic. Employable thermoplastics include for example polyolefin, especially polyethylene (PE), such as LD-PE, LLD-PE, UHMW-PE, or polypropylene (PP), polystyrene (PS), polyamide (PA), for example PA 6 or PA 6,6, polyesters, for example PET, PEN or PBT. In a preferred embodiment the layer E is in the form of a film. The use of PE film has been found to be particularly suitable since it forms a particularly good adhesive bond especially in the case of peroxidically crosslinking elastomer mixtures, thus making it possible in some cases to dispense with further adhesion promoters. The layer E has a particularly good adhesion-enhancing effect depending on the nature of the article and the nature of the further layers. It can be applied to the article blank with the aid of a radiant heater and pressure.

The article is preferably an air spring bellows, a metal-rubber element, a vibration damper, a damping element of a bearing, of a bushing or of a multilayered spring or conical spring. The article may alternatively be a tubular body. Tubular bodies are, for example, feed hoses of any kind, air spring bellows (cross-ply bellows, axial bellows) and compensators in various embodiments (e.g., torsion compensator, lateral compensator). The article may likewise be a drive belt.

The article is preferably an air spring bellows, a metal-rubber element, a vibration damper or a bearing, for example box bearing or a conical bearing, more particularly a molded article for rubber-sprung rail vehicle wheels.

1.-5. (canceled)

6. An article comprising a singlelayer or multilayer main body having elastic properties, wherein at least one layer D of the main body is constructed from a rubber mixture which is free from halogen-containing flame retardants and contains at least one carbon black having a BET surface area according to DIN-ISO 9277 between 35 and 140 m²/g and an oil absorption number (OAN) according to ISO 4656 between 70 and 140 ml/100 g.

7. The article as claimed in claim 6, wherein the amount of carbon black is 5 to 30 phr.

8. The article as claimed in claim 6, wherein the rubber mixture of the layer D further comprises zinc hydroxystannate or zinc stannate or a combination of zinc hydroxystannate and zinc stannate.

9. The article as claimed in claim 6, wherein the rubber mixture of the layer D further comprises magnesium hydroxide.

10. The article as claimed in claim 6, wherein the rubber mixture of the layer D further comprises calcium hydroxide

11. The article as claimed in claim 6, wherein the rubber mixture of the layer D further comprises melamine cyanurate

12. The article as claimed in claim 6, wherein the rubber mixture of the layer D further comprises zinc borate

13. The article as claimed in claim 6, wherein the rubber mixture of the layer D further comprises calcium borate

14. The article as claimed in claim 6, wherein the layer D comprises 100 phr of CR as the rubber component.

15. The article as claimed in claim 6, wherein the layer D comprises 100 phr of a blend of CR and NR (CR/NR) as the rubber component.

16. The article as claimed in claim 6 further comprising at least one additional layer C.

17. The article as claimed in claim 16, wherein the at least one additional layer C is a one-ply layer.

18. The article as claimed in claim 16, wherein the at least one additional layer C is a two-ply layer.

19. The article as claimed in claim 16, wherein the layer C forms an outer cap of the article.

20. The article as claimed in claim 16, wherein the layer C is a vulcanizable, thermoplastic-free, rubber mixture comprising at least one rubber component.

21. The article as claimed in claim 6, wherein the layer D further comprises at least one acid scavenger which reduces toxicity of smoke gas.

22. The article as claimed in claim 6, wherein the article is an air spring bellows.

23. The article as claimed in claim 6, wherein the article is a metal-rubber element, a vibration damper, a damping element of a bearing, a damping element of a bushing, a damping element of a multilayered spring, a damping element of a conical spring, a tubular body or a drive belt.
